(19) United States
(12) Patent Application Publication
(10) Pub. No.: US 2006/0248590 A1
(43) Pub. Date: Nov. 2, 2006

(54) System and method for protecting an information server

(76) Inventor: Teddy Christian Johnson, Issaquah, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,237

(22) Filed: Apr. 29, 2005

(51) Int. Cl. G06F 12/14; H04N 7/16; H04L 9/32; G06F 11/00; G06F 17/30; G06F 12/16; G06F 7/04; G06F 15/18; G06K 9/00; G08B 23/00; H03M 1/68; H04K 1/00; H04L 9/00

(52) U.S. Cl. 726/23; 726/26; 726/27

(57) ABSTRACT

A system and method are provided for reducing the risk of unauthorized intruder access to a protected information server from an application server. The method may include the operation of maintaining a data source object using the application server. The data source object can contain first information for accessing the protected information server. An additional operation is maintaining second information using the application server. The second information can be configured for accessing a security control server. After the application server has established a connection to the protected information server, the method can include the operation of causing the data source object to contain the second information for accessing the security control server.

### BACKGROUND

Computer hacking has been on the increase in recent years. In particular, organized crime and other knowledgeable individuals have been able to attack systems with more sophistication and more serious effects. In order to stop and contain such computer system attacks, it is valuable to be able to identify hacking attempts or detect intrusions into a computer system. The art of intrusion detection refers to detecting a wide variety inappropriate, malicious, or anomalous activity initiated by an intruder on a computer system.

Some intrusion detection systems operate on a host to detect malicious activity on that computer host. In a host-based system, the intrusion detection system examines the activity on each individual computer or host. Other types of intrusion detection systems known as network-based detection systems may operate on and examine network data flows. These systems may also attempt to identify the misuse of computer systems and monitor attacks or spoofs that originate from within the internal network. In a network-based system, the individual packets flowing through a network are analyzed. The network-based system may detect malicious packets that are designed to be overlooked by a firewall's simplistic filtering rules.

Other common approaches for intrusion detection are statistical anomaly detection and pattern-matching detection. An intrusion detection system may inspect many or even all of the inbound and outbound network activity. Suspicious patterns can then be identified that may indicate a network or system attack from someone attempting to break into or compromise a system.

Intrusion detection systems may be either passive or reactive system types. In a passive system, the intrusion detection system may detect a potential security breach, log the information, and signal an alert. This allows the system administrator to take appropriate action or take no action if the alert is a false alarm. In a reactive system, the intrusion detection system may respond to the threat by logging off a suspicious user or by reprogramming a firewall to block malicious network traffic.

In misuse detection, the intrusion detection system may analyze the data gathered and compare monitored data to large databases of attack signatures. Essentially, the intrusion detection system can look for a specific attack that has already been documented. Like a virus detection system, misuse detection software is only as good as the database of attack signatures that are used to compare packets against.

Anomaly detection allows a system administrator to define the baseline (i.e. normal) state of the network's traffic load, breakdown, protocol, and typical packet size. The anomaly detector monitors network segments and can compare the segments' states to the normal baselines in order to identify anomalies. When an anomalous condition is detected, then an alert can be sent to a system administrator.

A system administrator may receive a large number of anomaly or possible intrusion notifications during a relatively short time period. Sometimes the detection and “snorting” systems can send so many alerts and false alarms that the system administrators will turn down the sensitivity of the system. This reduction in sensitivity may allow hackers or other system intruders to enter the system without detection. In addition, patterns representing an actual intrusion may only be recognized after an attack or system damage has been completed.

### BRIEF DESCRIPTION OF THE DRAWINGS

FIG. 1 is a block diagram illustrating a prior art configuration of a network accessible web or application server in combination with database servers;

FIG. 2 is a block diagram illustrating an embodiment of a system for protecting an information server; and

FIG. 3 is flow chart illustrating an embodiment of a method for protecting an information server.

### DETAILED DESCRIPTION OF EXAMPLE EMBODIMENT(S)

Backend information servers or database servers are not generally intended to be accessed by any other servers or users than an application or web server which is authorized to retrieve information from the backend servers. An example of a web server may be an Apache web server, a Microsoft Internet Information Server (IIS), application service provider server, and similar servers. An example of an application server can be IBM's WebLogic, WebSphere, PeopleSoft ERP, Oracle Application Server and similar servers.

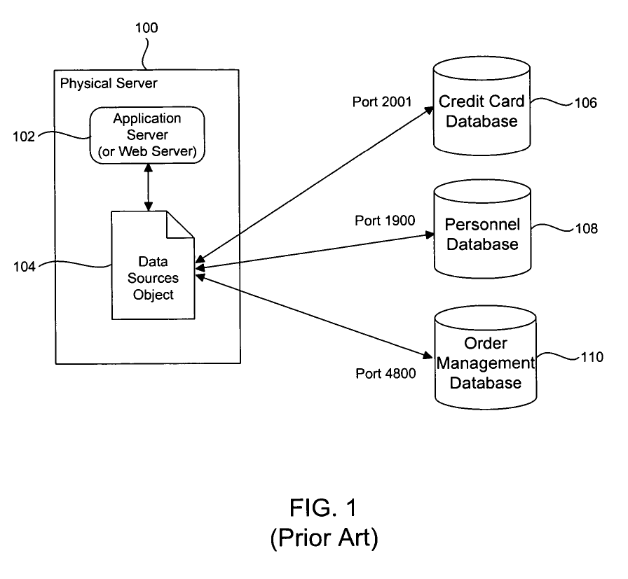

FIG. 1 illustrates that an application server 102 can be contained within a physical server 100. In particular, one of the weaknesses of this common architecture is that the authentication information (including a user name and password) is stored in a data sources object 104 or data sources file. This authentication information is generally stored in clear text and is unencrypted in order to allow the application server or web server to connect to the database servers 106, 108, and 110 and retrieve information for a particular software application.

As an application or web server becomes more important, the data in the database to which the application or web server connects also becomes more valuable. For example, a web or application server may access databases that contain personnel information. Personnel data may include salaries, stock options, 401 K portfolios, and similar human resources information. Databases may also contain financial information such as revenues, shipments, orders, and business critical information. Other types of information that may be contained in a backend database may be credit account and credit card information, customer support contract information, product orders, and detailed financial transaction operation data.

Web and application servers are quite commonly attacked using buffer overflow errors, unknown vulnerabilities, improper software configurations and other attack methods. When these attacks succeed, then the entire contents of the server's file system may be exposed. In many architectures, this type of server also exposes the data sources object 104 or authentication information for databases located behind a firewall. The data sources object may be stored in electronic memory or as a file in a non-volatile storage location. When an intruder finds this information, the value of a firewall or other security precautions is essentially nullified.

In a Unix system, this information is frequently stored in the “datasources.dat” file or in the “system.properties” file which are ASCII and XML documents containing much or all of the database access information. The use of standardized authentication file names and locations in many systems makes it that much easier to find database authentication information.

Once an intruder has been able to access the authentication information, then the intruder can access the backend databases 106, 108, and 110. Since the authentication files contain valid login information for backend databases, the intruder may immediately log into the backend databases undetected and freely view private credit card, personnel, customer, and other information for his own nefarious purposes.

In order to help overcome the problems described, a system and method are provided for protecting an information server from unauthorized intruder access. In particular, one embodiment of the present system provides protection to backend servers utilized by web or application servers which are located outside of a firewall or NAT (Network Address Translation) device.

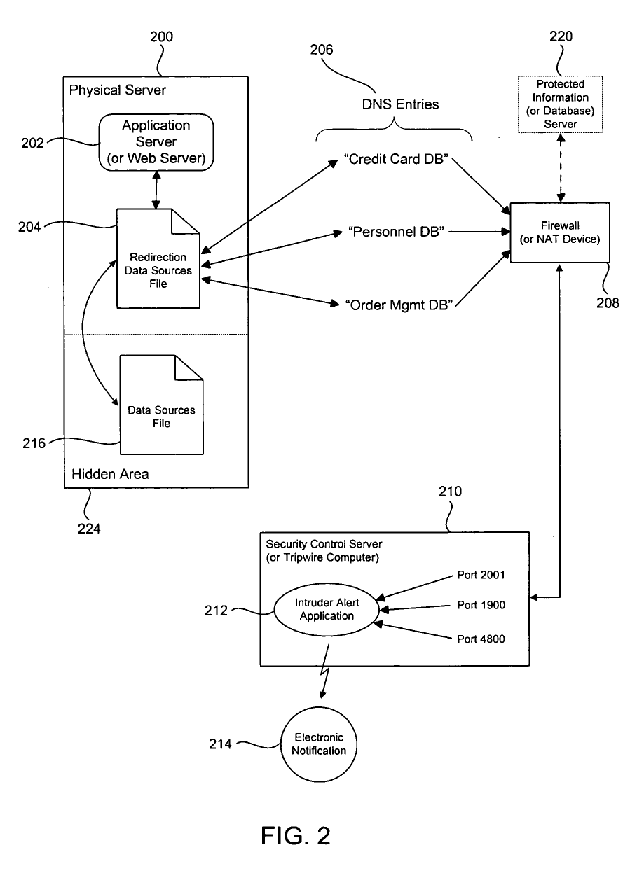

FIG. 2 illustrates a system for protecting an information server or backend database server from unauthorized intruder access. This system comprises an application server 202 that is executing on or contained within a physical server 200 (or computing device). The application server can be configured to receive information requests from external computing devices. For example, the application server can be a web server, application server, or other server type that is connected to the Internet, a local area network (LAN), or a networked communications system.

A protected information server 220 is in communication with the application server 202 to provide information and responses to information queries of the application server. The protected information server will generally be a database that is protected from outside networks by a firewall 208, a network address translation (NAT) device, or some similar protection configuration.

A data sources file or data sources object can be stored with the application server, and the data source file can contain first information to access the protected information server as described previously. This first information can be login or authentication and address information. For example, the data source file is likely to be stored on a hard drive of the physical server which the application server can access or in the physical server's file system.

Frequently these authentication files or data sources file can include,

1. Database server names and IP addresses

2. Port numbers

3. User names

4. Passwords

FIG. 2 illustrates that the authentication information, IP addresses, and DNS entries 206 are used to connect to the databases in a normal configuration.

However, in one embodiment, the actual data sources file 216 will be replaced by the redirection data sources file 204 once the application server has completed its startup phase and has logged into the protected information server, such as by copying or renaming. A redirection data sources file 204 contains second information to redirect an intruder or enable intruder access to a security control server 210 or “tripwire” computer. In another embodiment, the first information in the data sources file may be replaced by the second information in the redirection data sources file.

The replacement of the data source file can also include moving the data source file to a hidden area 224 and file name that is unlikely to be investigated by an intruder. Then when an intruder accesses the system, the intruder will find and open the redirection data sources file 204 and try to access the server address and ports using the login and password described in the redirected file. When the intruder tries to make the connection, the communication may pass through a firewall 208 or other NAT device. The intruder will then expect to access a database with sensitive information. For example, the intruder may believe he is connecting to a backend database server such as credit card database, personnel database, or business information database located behind the firewall.

Instead, a security control server 210 can be provided to receive access from the intruder based on the “fictitious” or redirected addresses and login information contained in the redirection data sources file 204. In other words, an intruder will receive a fictitious or altered database address and port, even though the login information will actually work to login to a tripwire server. Accordingly, the intruder will be able to login to a server, but the intruder will not have access to the expected information.

One embodiment takes advantage of the fact that web servers and application servers primarily read their configuration files just once on server startup. Of course, some servers are able to re-read configuration files if an operator explicitly sends a signal. In practice, the re-read functionality is very rarely used because restarting the entire web server or application server is comparatively quick. However, if this functionality is desired, the re-reading of the files function may also be combined with an embodiment as needed.

A notification application or intruder alert application 212 can be running on the security control server 210. By executing a notification application on the security control server, this allows an intruder or unauthorized personnel to login to a waiting application that is listening on the port the intruder has obtained. When the notification application is accessed or communicated with by an intruder, then an embodiment of the system may receive a positive indication that someone unauthorized is trying to access the backend databases using the clear text login information from the redirection data sources file.

As a result, an intruder access notification can be sent to a network administrator in order to alert internal personnel of the rogue access to the application or web server and backend database server. An electronic notification 214 can be provided to the administrator of the break-in using email, instant messaging, electronic paging, a cell phone, paging, or any other type of messaging device. The immediate notification is valuable because it allows the system administrator to know in nearly real-time that an intruder has accessed the web server and then used the clear text login information to try to access backend databases.

More than one security control computer 210 can be provided behind the firewall to respond to separate database names and IP addresses. Alternatively, all of the DNS or IP addresses in the data sources file may point to one security control computer. The aliases to the database names and IP addresses can all be routed to the same security control computer through the firewall.

In some embodiments, the security control server 210 or tripwire server can have a tripwire port that matches to the same port through which the database would normally communicate, but instead that port may map to the intruder alert application 212. This type of mapping may increase the feeling of authenticity for the intruder. For example, some databases within an organization may be configured to communicate on port 2001. Thus, allowing an intruder to login to the security control server through port 2001 also appears more authentic. Alternatively, a completely different port number can be provided in the data sources file so that any login attempt is more clearly intentional and not accidental.

One embodiment helps solve the problem of allowing intruders or hackers to access clear text passwords and authentication information for database servers that is stored on an application or web server. In the past, one solution has been to encrypt the authentication information, but even if the intruder is not able to access the backend database, this does not solve the problem of being able to catch the intruder. Moreover, if the intruder is able to decrypt the authentication file, then system administrators are unlikely to even know that decryption of an authentication file has happened.

In contrast, certain embodiments can immediately detect when a web or application server has been compromised. In addition, the unauthorized access is reported while the database login attempt is actually occurring. Past solutions for detecting hacking attempts have relied upon a large amount of data being gathered to detect unusual network activity or database queries. Other types of pattern matching and heuristics have previously been used to detect when a hacking attempt may be occurring. Unfortunately, these data gathering methods typically produce so many fictitious alarms that they are quite often useless in detecting the actual intrusions.

One example embodiment enables the hiding of backend server identification and authentication information. This makes it difficult for an intruder to compromise a web or application server. In addition, just because a web or application service is compromised, this does not mean that all the databases which communicate with that server will also be immediately compromised. Hiding the authentication information makes it more difficult to access protected databases.

As mentioned, the security control server informs system administrators when the web application or server has actually been compromised. This means that the intruder is less able to lurk in the compromised system while silently collecting confidential information on an ongoing basis. This protects the web and application server from later destruction and also thwarts ongoing attempts against the database server side.

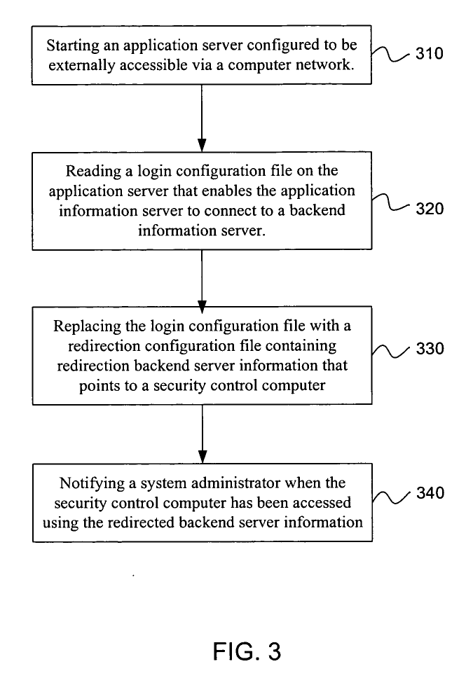

FIG. 3 illustrates a flowchart for an embodiment of a method for protecting an information server from unauthorized intruder access. The method includes the operation of starting an application server configured to be externally accessible via a computer network. This startup step is illustrated in block 310. As described previously, the application server may be a web server, FTP server, or another type of application server accessible through a network or the Internet. Examples of an application server may be an enterprise resource application (such as SAP), Oracle Application Server, Zope, Java Application Server, or similar application servers.

A further operation is reading a login configuration file on the application server that enables the application information server to connect to a backend information server, as in block 320. The application server reads the login configuration file primarily at startup and the fact that the configuration file is used primarily at startup is used to provide additional security.

Another operation of this example embodiment is replacing the login configuration file with a redirection configuration file containing redirection backend server information that points to a security control computer, as illustrated in block 330. This means that once the web or application server has been started and the connection has been made to the backend database, the data sources file containing the backend database login information will be replaced with a redirection or fictitious login data file. If anyone accesses this redirected file, externally or internally, then the fictitious database access information such as the hostnames, ports, logins, and passwords may be revealed. This redirected information can then point to a security control computer or tripwire machine. In the event an intruder attempts to connect to the backend databases, the intruder can activate the security control computer(s).

Another operation is notifying a system administrator when the security control computer has been accessed using the redirected backend server information, as in block 340. The triggering of an alarm through the security control server is very focused because it only notifies the system administrator when the security control machine is actually accessed through a specific database name port and login. Other misdirected or accidental attempts to access the server will not be recognized. Thus, just a very specific and guided attempt to attack the database servers will be registered by this system and method.

An example of the operation for replacing a login configuration file (or data sources file) with the redirection configuration file can also include the operation of hiding the real login configuration file. This file hiding may be performed by moving the login configuration file to a server location that is unlikely to be accessed or guessed by the intruder. In particular, the file can be hidden by using a sacrificial file or command in the operating system which would not be expected to be switched or used as a hiding place. Such commands may be operating system commands which are present in default installations of the operating system but are never used.

For example, Unix servers might use the /bin/uucico command. The /bin/uucico is used to implement the obsolete UUCP mail system. This is also true of the /bin/uustat command. The /bin/umodem command implements the obsolete XMODEM protocol. Such obsolete commands are typically stored on the server due to the legacy nature of many operating systems such as Unix, Windows, and others. Since they are never used, they may be sacrificed (i.e., their functionality can be modified or changed) without ever arousing suspicion. Thus, the actual login configuration file can be stored under these or other file names that are not currently used. The storage of files under such command names makes it difficult for an intruder to find the file even if the intruder tries to search for the file, because it is hidden in plain view, among the hundreds or thousands of ordinary commands and files which are normally present on Unix, Windows, and other operating systems.

A programming wrapper may be created to reprogram the “rm” command which is normally used for deleting files in the Unix operating system. When the “rm” command is used by the web or application server's startup script in a standard manner, the “rm” command will actually detect that it is being used in a special case and will move the real datasources.dat or the real login configuration file to an obscure location and re-name the file of one of the sacrificial command file names, in addition to performing its standard delete functionality. However, if the “rm” command is used with other files, it will delete files in a conventional manner.

In this case, the datasources.dat can be re-named to “uucico” and moved to the appropriate location. This example could also be configured to be used with many different file replacement configurations as long as the method relocates the real authentication file to an area and name which is normally present, and thus the area and/or name will not be interesting to the intruder.

Alternatively, the login configuration file may be a hidden file that is moved to an obscure directory that cannot be seen with any normal directory commands. This is more risky because there are utilities to help find hidden files. In an example embodiment, once the real “rm” command has been reprogrammed to move the login configuration files, then when the server startup script runs, the “rm” command can be used to move the login configuration file. This reconfigured “rm” command can simply replace the original configuration file with the redirection configuration file and then hide the real login configuration file. One skilled in the art would be able to recode the “rm” command to address this special functionality.

Another example of a convenient command that might have its functionality secretly augmented would be the /bin/echo command which is normally used to print commands or files to the screen. In this embodiment, the “echo” command can be reprogrammed to hide the login configuration file when invoked with a particular special argument string. For example, the “echo” command can be used with a special argument string such as “Acme Widgets web server started” or some other trigger string. The trigger string would activate a special case within the “echo” command, then the “echo” command can be programmed to swap the login configuration file with the redirection configuration file. Thus, this command can be activated and used in startup scripts without an intruder realizing that the backend server access files are secretly being switched (in addition to the standard “echo” function being performed).

In a Unix based example, a modified “echo” command can move the real datasources.dat into a hiding place once the application or web server has used the authentication data. Then the “echo” command can also move the fictitious datasources.dat file into place. Any intruder who tries to access the database specified by the fictitious datasource.dat will set off the security control server (i.e. the tripwire).

This example of a replacement system and method works even if the backend database authentication or the login configuration files (systems.properties and datasources.dat) are encrypted. An intruder may try to read and decrypt the file if he finds it. If the intruder is successful in decrypting the file, the intruder will have access to the entire database system. Under this system, what an intruder will decrypt (if he can) is fictitious database access information.

It is also valuable for the notification or intruder alert application to be able to notify a system administrator of not only the host name of the compromised server but also of the host name of the backend database server which the intruder has tried to access. To perform this function with a single security control server, a configuration setup can be programmed into the security control computer (or tripwire computer) that maps port numbers to the host names of the servers that the single security control server is masquerading as.

The present implementation provides at least a two-fold benefit to the information systems being supported. The insertion of fictitious authentication information and login data allows the system administrators to prevent intruders from compromising the backend database servers. In addition, the system provides notification that allows the system administrators to know when an intruder has viewed the fictitious login information and tried to access the ports provided in the redirection or tripwire file.

Another valuable implementation embodiment is to have one intruder alert application running for each web server or application server being monitored. That way each intruder alert application can report which particular machine has been compromised.

For example, suppose there are two servers running web servers: 1. ECOM.HP.COM 2. VECTRA.HP.COM. ECOM.HP.COM may connect to 23 different database servers and VECTRA.HP.COM may connect to 11 database servers. This means that each server has as many as 23 and 11 database authentication tuples (host name, port, user name, and password). To monitor these two servers, we may use two intruder alert processes on a security control server or tripwire for the HP.COM domain where the first process monitors 23 ports and the second process monitors 11 ports.

Another possible implementation is to merely create 34 DNS aliases for all the fictitious Internet Protocol (IP) addresses (23+11=34 in the example above) and have them mapped to TRAP.HP.COM. However, the careful hacker or intruder will do an “nslookup” and notice that all of the IP entries in the datasources.dat and system.properties files map to the same server. In addition, if the suspicious name of “TRAP.HP.COM” is used, this may also tip an intruder off to the protection system.

A stealthier implementation is to create full-fledged authentic DNS entries and then secretly reroute the DNS entries to the TRAP.HP.COM by using network address translation (NAT) on a router. This use of NAT is illustrated in FIG. 2. NAT is a technology that allows a router to map one IP address to another. This is done in a fashion that is totally undetectable by a hacker or intruder.

While the forgoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for reducing risk of unauthorized intruder access to a protected information server from an application server, comprising the steps of:
maintaining a data source object using the application server, the data source object containing first information for accessing the protected information server;
maintaining second information using the application server, the second information being configured for accessing a security control server; and
after the application server has established a connection to the protected information server, causing the data source object to contain the second information for accessing the security control server.

2. A method as in claim 1, wherein the second information in the data source object is configured to contain information to enable an intruder who attempts to access the protected information server to instead access the security control server.

3. A method as in claim 1, further comprising the step of storing the data source object as a data source file.

4. A method as in claim 1, further comprising the step of maintaining authentication and address information for the protected information server as the first information in the data source object.

5. A method as in claim 1, further comprising the step of maintaining authentication and address information for the security control server as the second information in the data source object.

6. A method as in claim 1, further comprising the step of notifying a system administrator when the security control computer has been accessed using the second information configured for accessing the security control server.

7. A method as in claim 1, further comprising the step of moving the first information for accessing the protected information server to a hidden location.

8. A method as in claim 1, further comprising the step of running an intruder alert application on the security control computer.

9. A method as in claim 8, further comprising the step of determining when the intruder alert application has been accessed.

10. A method as in claim 9, further comprising the step of sending a system administrator a notification when the intruder alert application has been accessed.

11. A method as in claim 10, further comprising the step of sending a notification selected from the group consisting of an email, an instant message, an electronic page, and a wireless device message.

12. A method as in claim 1, wherein the step of replacing the first information in the data source object with the second information, further comprises the step of using the second information to point at a tripwire computer.

13. A system for reducing risk of unauthorized intruder access to a protected information server from an application server, comprising:
a data source object containing first information for accessing the protected information server, the data source file being stored by the application server;
second information being configured for accessing a security control server, the second information being maintained by the application server; and
wherein after the application server has established a connection to the protected information server, the data source object is caused to contain the second information for accessing the security control server.

14. A system as in claim 13, wherein the second information for the data source object is configured to contain information to enable an intruder who attempts to access the protected information server to instead access the security control server.

15. A system as in claim 13, wherein the data source object is a data source file.

16. A system as in claim 13, wherein the first information in the data source object includes authentication and address information for the protected information server.

17. A system as in claim 13, wherein the second information in the data source object includes authentication and address information for the security control server.

18. A system as in claim 13, further comprising a notification application executing on the security control server, the notification application being configured to notify a system administrator when a security control server is accessed.

19. A system as in claim 18, wherein the notification application is configured to notify a system administrator using a notification method selected from the group consisting of an email, an instant message, an electronic page and a wireless device message.

20. A system as in claim 13, wherein the application server is a web server or file transfer protocol (FTP) server.

21. A system as in claim 13, wherein the data source object contains an internet protocol (IP) address, port number, username and password for at least one security control server.

22. A system as in claim 13, wherein the security control server further comprises a tripwire server having a tripwire port corresponding to an actual port accessible on the protected information server.

23. A system as in claim 13, further comprising a firewall device to enable connections to the security control server.

24. A system as in claim 23, wherein the firewall device further comprises a network address translation device (NAT) configured to enable connections to the security control server.

25. A system for reducing risk of unauthorized intruder access to a protected information server from an application server, comprising:
a data source file means containing first connection information means for accessing the protected information server, the data source means being stored by an application server;
second connection information means for accessing a security control server, the second information means being maintained by the application server; and
a replacement means for causing the data source object to contain the second information for accessing the security control server, wherein the replacement takes place after the application server has established a connection to the protected information server.

26. A system as in claim 25, further comprising a notification application means for notifying a system administrator when the security control server is accessed.

27. An article of manufacture including a computer usable medium having computer readable program code embodied therein for reducing risk of unauthorized intruder access to a protected information server from an application server, comprising computer readable program code capable of performing the operations of:
maintaining a data source object using the application server, the data source object containing first information for accessing the protected information server;
maintaining second information using the application server, the second information being configured for accessing a security control server; and
after the application server has established a connection to the protected information server, causing the data source object to contain the second information for accessing the security control server.
